(19) United States
(12) Patent Application Publication
(10) Pub. No.: US 2009/0164443 A1
(43) Pub. Date: Jun. 25, 2009

(54) DATABASE PERFORMANCE MINING

(76) Inventors: Jo A. Ramos, Grapevine, TX (US); John B. Rollins, Southlake, TX (US)

Correspondence Address: HOFFMAN WARNICK LLC, 75 STATE ST, 14 FL, ALBANY, NY, 12207, US

(21) Appl. No.: 11/960,115

(22) Filed: Dec. 19, 2007

(51) Int. Cl. G06F 17/30; G06F 7/00

(52) U.S. Cl. 707/5; 707/6; 707/E17.017; 707/E17.014

(57) ABSTRACT

A system, method and program product for analyzing performance of a system comprised of a database and its related operating environment. A system is provided that includes: a set of monitoring tools for monitoring event data from a database application and from an operating environment running the database application; a performance data warehouse for storing the event data; a modeling system for generating a performance mining model of the database system based on the event data stored in the performance data warehouse; and a system for comparing a stream of current event data against the performance mining model to identify performance issues in the database system.

### FIELD OF THE INVENTION

This disclosure relates generally to system and database performance, and more particularly relates to a system and method for utilizing data mining techniques to analyze workloads and metrics for both an operating system and a database application to discover performance bottlenecks that degrade overall performance.

### BACKGROUND OF THE INVENTION

Given the complexities involved with operating large-scale database systems, the ability to provide high performance to the end users remains an ongoing challenge. Any number of factors can slow down the performance of a database. Database vendors currently provide database monitoring capabilities that are limited to analyzing internal database objects rather than the entire operating environment. In many cases, events in the database can impact the overall system behavior, while overall system behavior can affect database performance. Although some existing monitoring tools can oversee the whole operating environment, they are limited to displaying specific information about events occurring in the system. These monitoring tools do not have the ability to recognize impending performance problems arising from certain combinations of events occurring simultaneously or in a sequence.

A major contributor to database and/or system performance degradation is the concurrency of different types of workloads (e.g., query, database maintenance, system operation, etc.). Significant efforts and costs are devoted to optimizing queries and allocating job execution to avoid performance bottlenecks and keep a system running smoothly. If performance bottlenecks could be anticipated or predicted as likely to occur under certain sets of conditions, system tuning could be performed prior to the formation of bottlenecks and avoid the problems associated with bottlenecks. However, there are no current systems that provide such a solution.

### SUMMARY OF THE INVENTION

The present invention relates to a system, method and program product for analyzing performance of a database system. In one embodiment, there is a system for analyzing performance of a database system, comprising: a set of monitoring tools for monitoring event data from a database application and from an operating environment running the database application; a performance data warehouse for storing the event data; a modeling system for generating a performance mining model of the database system based on the event data stored in the performance data warehouse; and a system for comparing a stream of current event data against the performance mining model to identify performance issues in the database system.

In a second embodiment, there is a program product stored on a computer readable medium for analyzing performance of a database system, comprising: program code for capturing and storing event data from a database application and from an operating environment running the database application; program code for generating a performance mining model of the database system based on the event data; and program code for comparing current event data against the performance mining model to identify performance issues in the database system.

In a third embodiment, there is a method for analyzing performance of a database system, comprising: capturing and storing event data from a database application and from an operating environment running the database application; generating a performance mining model of the database system based on the event data; and comparing current event data against the performance mining model to identify performance issues in the database system.

In a fourth embodiment, there is a method for deploying a system for analyzing performance of a database system, comprising: providing a computer infrastructure being operable to: capture and store event data from a database application and from an operating environment running the database application; generate a performance mining model of the database system based on the event data; and compare current event data against the performance mining model to identify performance issues in the database system.

The disclosure describes a process for applying data mining algorithms (e.g., clustering, associations, and sequences) against database and system performance and utilization metrics and query workloads to discover unexpected combinations of events and/or to discover sequences of events that cause performance degradation in the overall operating system or in the database application. The information enables a database administrator or an automated process to monitor the database system proactively and take remedial actions before the system degrades significantly.

The data mining algorithms create models that can be applied in a real-time scoring process as system and database performance data streams into a monitoring tool. Scoring can be automated within the database to detect emerging performance bottlenecks in real time.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer infrastructure having a database system and performance mining system in accordance with an embodiment of the present invention.

FIG. 2 depicts an example of one cluster from a performance mining model (created using a data mining clustering algorithm) in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

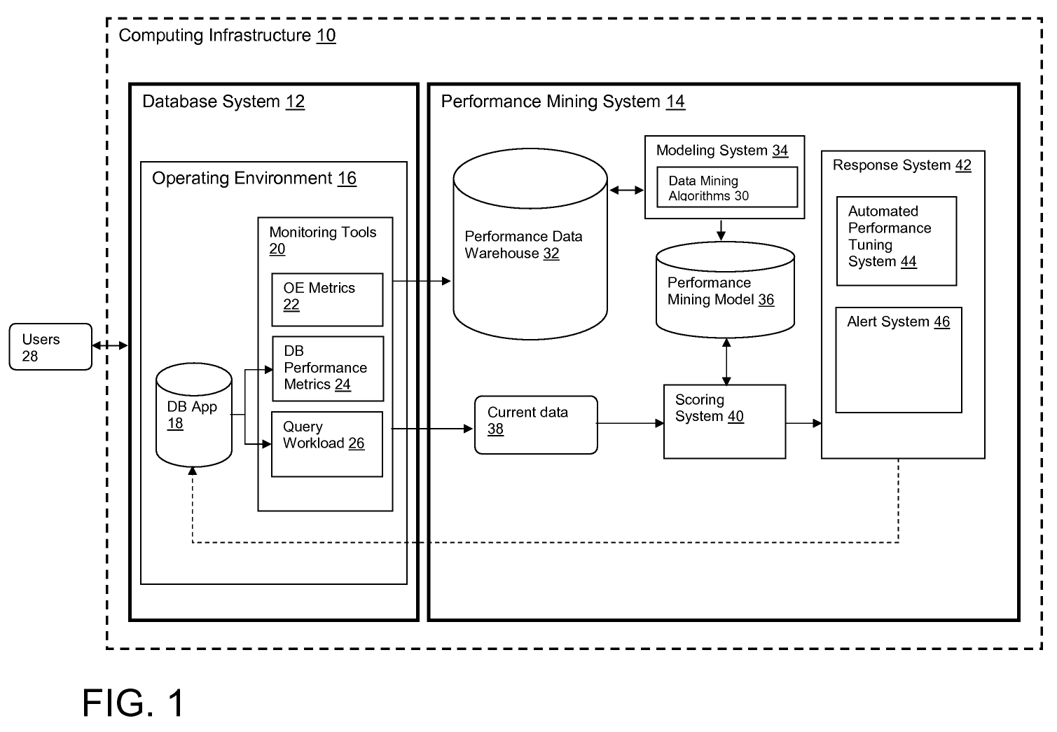

Referring now to the drawings, FIG. 1 depicts a computing infrastructure 10 that includes a database system 12 and a performance mining system 14 that models historical performance data from the database system 12 and utilizes the model to proactively identify performance degradations based on a stream of current data 38. Database system 12 generally includes an operating environment (OE) 16 running a database (DB) application 18 and a set of monitoring tools 20. Operating environment 16 generally comprises any operating system and computing platform for running the database application 18. Database application 18 may comprise any type of database program, e.g., a relational database management system (RDBMS). Performance mining system 14 generally includes a performance data warehouse 32, a modeling system 34, a scoring system 40, and a response system 42.

As noted, database system 12 includes a set of monitoring tools 20 that monitor both the database application 18 and the operating environment 16. As shown, monitoring tools 20 are incorporated into the database system 12; however, they could be implemented separately. Monitoring tools 20 generally include: (1) operating environment metrics 22 that monitor utilization/performance of operating environment related features, e.g., CPU usage, pages/second, percentage of memory utilized, input/output usage, etc.; (2) database performance metrics 24 that monitor various performance features of the database application 18, such as timeouts, table locks, etc.; and (3) query workload 26 that monitors the number of queries being submitted by users 28 against the database application 18.

On a regular, ongoing basis, data records from the monitoring tools 20 are collected and stored in a performance data warehouse 32, within the performance mining system 14. The performance data warehouse 32 thus contains historical performance and utilization information about the operating environment 16 and database application 18. Performance data warehouse 32 may, for example, categorize the data from the monitoring tools 20 as unique events, such as: CPU usage, database timeouts, lockouts, number of queries, etc.

A modeling system 34 is used to analyze the data in the performance data warehouse 32 and create a performance mining model 36 that characterizes behavior patterns of the data. Modeling system 34 generally includes data mining algorithms 30, which, for instance, utilize techniques such as clustering, associations, or sequences, or other applicable data mining techniques to create the performance mining model 36. In one illustrative embodiment, a data mining analyst may create models that enable the analyst to discover and quantify combinations of events that may occur simultaneously or sequentially and cause performance bottlenecks. These behavioral patterns or models may be stored in a database table, e.g., in the industry-standard Predictive Model Markup Language (PMML) format.

Performance mining model 36 typically tracks data from a set of different events over time. Within performance mining model 36 there are any number of different behavioral patterns that are modeled among the events that indicate some condition, such as a potential bottleneck. For instance, performance mining model 36 may include a first behavior pattern in which events A, B and C are abnormally high during a given time period, a second behavior pattern in which events D and E are lower than normal, etc. Note that some of the behavior patterns may be indicative of performance degradation issues, while other behavior patterns may be indicative of normal operations.

In the case where the data mining technique of clustering is used for modeling, performance mining model 36 may include N different clusters (i.e., groups or segments) with each cluster representing a particular behavioral pattern for a set of events. For instance, a cluster may track combinations of simultaneous events that are known to cause a performance bottleneck. In another example in which the data mining technique of sequences is used for modeling, a sequences model may track a sequence of certain events that, with a certain confidence, indicate an emerging performance bottleneck.

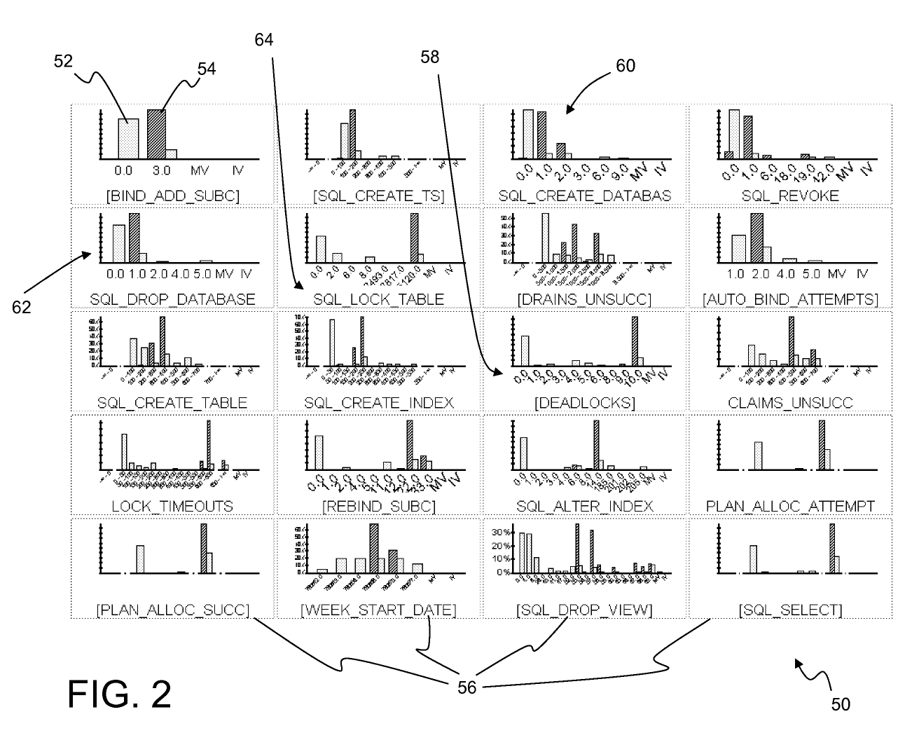

FIG. 2 depicts an illustrative behavioral pattern for a model (in this case, a clustering model). In this example, one cluster of the model is represented by a graphical visualization 50. The model tracks twenty different events 56 where each event is represented as a histogram of collected data. Each histogram represents the statistical distribution of a particular event in the model. In this example, lightly shaded histogram bars of data 52 reflect all of the data captured to date (or for some period) in the performance data warehouse 32. Overlaid on each histogram, darker shaded histogram bars 54 reflect data for this specific cluster 50. As noted, a typical clustering model would include a plurality of clusters wherein each cluster represents a distinct behavioral pattern of performance, whereas only one cluster is depicted in FIG. 2. In this case, the cluster 50 is characterized by a high number of deadlocks 58 in combination with high levels of database creation/drop activities 60 and 62, respectively, high numbers of table locks 64, and other events represented by the other histograms. This pattern of events may be indicative of a particular condition, such as an impending performance bottleneck. Accordingly, an indicative condition for each cluster may be stored with the performance mining model 36.

Referring again to FIG. 1, in addition to collecting and storing data in the performance data warehouse 32, current data 38 from monitoring tools 20 is also streamed into the performance mining system 14 for real time (or near real-time) analysis. In particular, current data 38 is passed to a scoring system 40 that scores the current data 38 in real time. Scoring system 40 applies the performance mining model 36 to the current data 38 and generates a score. The score may for instance be based on the closest behavior pattern in the performance mining model 36, how close the close the current data 38 matches a behavior pattern, etc. In accordance with the type of performance mining model 36 being applied, the final score reflects a current behavior pattern of events occurring in the operating system 16 and database application 18.

If the current behavior pattern of events is scored as being similar to any of the behavior patterns previously identified in the performance mining model 36 as representing a performance issue, then an appropriate action may be initiated by response system 42. In one illustrative embodiment, an automated performance tuning system 44 is executed to tune the database system 12 by, e.g., changing database configuration parameters or resolving conflicting system processes. In another embodiment, an alert system 46 is provided to issue an alert, e.g., to a database administrator, for investigation and/or intervention.

It is understood that database system 12 and performance mining system 14 may be implemented within any type of computing infrastructure 10. As such, the database system 12 and performance mining system 14 may be implemented separately or together by one or more computer systems. Such computer systems generally include a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. The bus provides a communication link between each of the components in the computer system and likewise may comprise any known type of transmission link, including electrical, optical, wireless, etc. Additional components, such as cache memory, communication systems, system software, etc., may be incorporated into each computer system.

Access to the computer infrastructure 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a performance mining system 14 could be created, maintained and/or deployed by a service provider that offers the functions described herein for customers. That is, a service provider could offer to deploy or provide the ability to provide database performance mining and analysis as described herein.

It is understood that in addition to being implemented as a system and method, the features may be provided as a program product stored on a computer-readable medium, which when executed, enables computer infrastructure 10 to provide a database system 12 and performance mining system 14. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the placement and functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for analyzing performance of a database system, comprising:
a set of monitoring tools for monitoring event data from a database application and from an operating environment running the database application;
a performance data warehouse for storing the event data;
a modeling system for generating a performance mining model of the database system based on the event data stored in the performance data warehouse; and
a system for comparing a stream of current event data against the performance mining model to identify performance issues in the database system.

2. The system of claim 1, wherein the monitoring tools gather operating environment metrics, database performance metrics, and query workload data.

3. The system of claim 1, wherein the modeling system generates the performance mining model using a modeling technique selected from the group consisting of: clustering, associations, and sequences.

4. The system of claim 1, wherein the system for comparing the stream of current event data against the performance mining model generates a score for the stream that indicates a type of behavior pattern.

5. The system of claim 4, further comprising an automated performance tuning system that automatically tunes the database system if the score is associated with a performance degradation condition.

6. The system of claim 4, further comprising a system for generating an alert if the score is associated with a performance degradation condition.

7. The system of claim 1, wherein the performance mining model includes a plurality of clusters, wherein each cluster represents a distinct behavioral pattern, wherein each cluster is represented as a plurality of histograms, and wherein each histogram captures historical data of a monitored event.

8. A program product stored on a computer readable medium for analyzing performance of a database system, comprising:
program code for capturing and storing event data from a database application and from an operating environment running the database application;
program code for generating a performance mining model of the database system based on the event data; and
program code for comparing current event data against the performance mining model to identify performance issues in the database system.

9. The program product of claim 8, wherein the event data includes operating environment metrics, database performance metrics, and query workload data.

10. The program product of claim 8, wherein the performance mining model is created using a modeling technique selected from the group consisting of: clustering, associations, and sequences.

11. The program product of claim 8, wherein the program code for comparing the current event data against the performance mining model generates a score for the stream that reflects a type of behavior pattern for the current event data.

12. The program product of claim 11, further comprising program code that automatically tunes the database system if the score is associated with a performance degradation condition.

13. The program product of claim 11, further comprising program code for generating an alert if the score is associated with a performance degradation condition.

14. The program product of claim 8, wherein the performance mining model includes a plurality of clusters, wherein each cluster represents a distinct behavioral pattern, wherein each cluster is represented as a plurality of histograms, and wherein each histogram captures historical data of a monitored event.

15. A method for analyzing performance of a database system, comprising:
capturing and storing event data from a database application and from an operating environment running the database application;
generating a performance mining model of the database system based on the event data; and
comparing current event data against the performance mining model to identify performance issues in the database system.

16. The method of claim 15, wherein the event data includes operating environment metrics, database performance metrics, and query workload data.

17. The method of claim 15, wherein the performance mining model is created using a modeling technique selected from the group consisting of: clustering, associations, and sequences.

18. The method of claim 15, wherein comparing the current event data against the performance mining model generates a score for the stream that reflects a type of behavioral pattern for the current event data.

19. The method of claim 18, further comprising automatically tuning the database system if the score is associated with a performance degradation condition.

20. The method of claim 18, further comprising generating an alert if the score is associated with a performance degradation condition.

21. The method of claim 15, wherein the performance mining model includes a plurality of clusters, wherein each cluster represents a distinct behavioral pattern, wherein each cluster is represented as a plurality of histograms, and wherein each histogram captures historical data of a monitored event.

22. A method for deploying a system for analyzing performance of a database system, comprising:
providing a computer infrastructure being operable to:
capture and store event data from a database application and from an operating environment running the database application;
generate a performance mining model of the database system based on the event data; and
compare current event data against the performance mining model to identify performance issues in the database system.
